(19) United States
(12) Patent Application Publication
(10) Pub. No.: US 2009/0108590 A1
(43) Pub. Date: Apr. 30, 2009

(54) ELECTRONIC APPARATUS

(75) Inventors: Katsuji Mabuchi, Gifu-shi (JP); Naoteru Matsubara, Ichinomiya-shi (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/258,217

(22) Filed: Oct. 24, 2008

(30) Foreign Application Priority Data
Oct. 26, 2007 (JP) 2007-278770

(51) Int. Cl. F03G 7/08; H02N 1/08

(52) U.S. Cl. 290/1 R; 310/300

(57) ABSTRACT

An electronic apparatus includes a power generator including a movable portion displaced by kinetic energy acting on an electronic apparatus body and a conversion portion converting displacement of the movable portion to electric energy, wherein the movable portion of the power generator is arranged at a position separated from a support portion of the electronic apparatus body.

### CROSS-REFERENCE TO RELATED APPLICATIONS

The priority application number JP2007-278770, Electronic Apparatus, Oct. 26, 2007, Katsuji Mabuchi, Naoteru Matsubara, upon which this patent application is based is hereby incorporated by reference.

### BACKGROUND OF THE INVENTION

1. Field of the Invention

The present invention relates to an electronic apparatus, and more particularly, it relates to an electronic apparatus comprising a power generator converting kinetic energy acting on an electronic apparatus body to electric power.

2. Description of the Background Art

An electronic apparatus comprising a power generator converting kinetic energy acting on an electronic apparatus body to electric power is known in general.

A conventional electronic apparatus comprises a power generator including a permanent magnet stored in a cylindrical container in a vibratory manner and a coil wound around the container. In this conventional electronic apparatus, the permanent magnet (movable portion) vibrates following displacement of the electronic apparatus. Thus, electric power can be generated in the coil wound around the container by electromagnetic induction.

### SUMMARY OF THE INVENTION

An electronic apparatus according to a first aspect of the present invention comprises a power generator including a movable portion displaced by kinetic energy acting on an electronic apparatus body and a conversion portion converting displacement of the movable portion to electric energy, wherein the movable portion of the power generator is arranged at a position separated from a support portion of the electronic apparatus body. The concept of the “support” is a wide concept including a case of grasping by a hand of a user and a case of wearing the electronic apparatus on a body or clothing of the user. The “position separated from the support portion” is a “position included in a region on a side opposite to the support portion with respect to a center of the electronic apparatus body” or a “position included in a region different from a region belonging in all or at least a half of the support portion in a case where the electronic apparatus body is divided in two in a certain direction”, for example.

A portable telephone according to a second aspect of the present invention comprises a power generator including a movable portion displaced by kinetic energy acting on an electronic apparatus body and a conversion portion converting displacement of the movable portion to electric energy, wherein the movable portion of the power generator is arranged at a position separated from a support portion of the electronic apparatus body.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front elevational view showing an electronic apparatus according to a first embodiment of the present invention;

FIG. 2 is a side elevational view showing the electronic apparatus according to the first embodiment of the present invention;

FIG. 3 is a side elevational view (partial sectional view) showing a power generator of the electronic apparatus according to the first embodiment of the present invention;

FIG. 4 is a sectional view taken along the line 200-200 in FIG. 3;

FIG. 5 is a sectional view showing a power generator of an electronic apparatus according to a second embodiment of the prevent invention;

FIG. 6 is a plan view showing the power generator of the electronic apparatus according to the second embodiment of the prevent invention;

FIG. 7 is a front elevational view showing an electronic apparatus according to a third embodiment of the present invention;

FIG. 8 is a front elevational view showing an electronic apparatus according to a first modification of the first embodiment of the present invention;

FIG. 9 is a side elevational view showing the electronic apparatus according to the first modification of the first embodiment of the present invention;

FIG. 10 is a front elevational view showing an electronic apparatus according to a second modification of the first embodiment of the present invention; and

FIG. 11 is a side elevational view showing the electronic apparatus according to the second modification of the first embodiment of the present invention.

### DESCRIPTION OF THE PREFERRED EMBODIMENTS

Embodiments of the present invention will be hereinafter described with reference to the drawings.

### First Embodiment

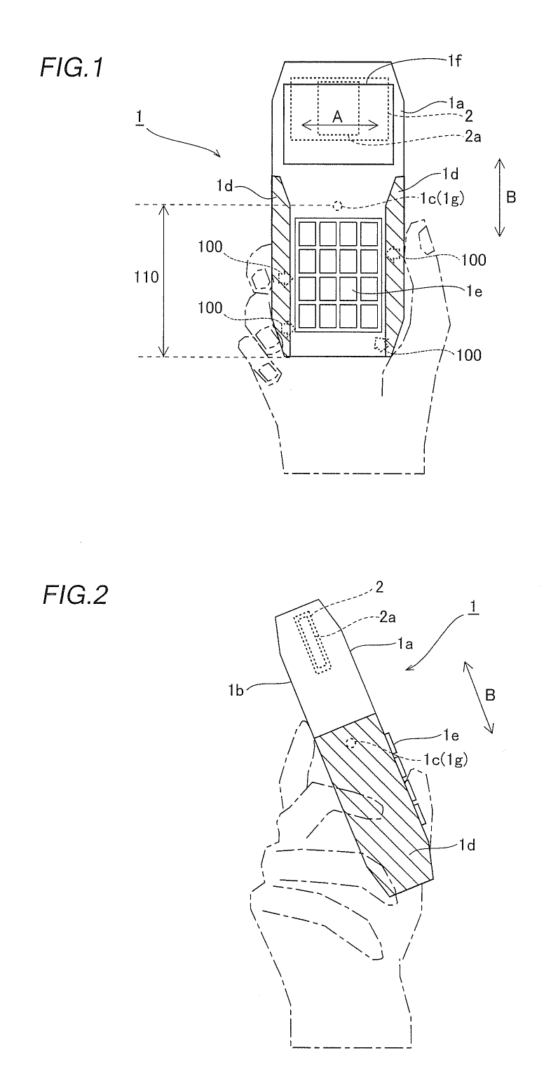

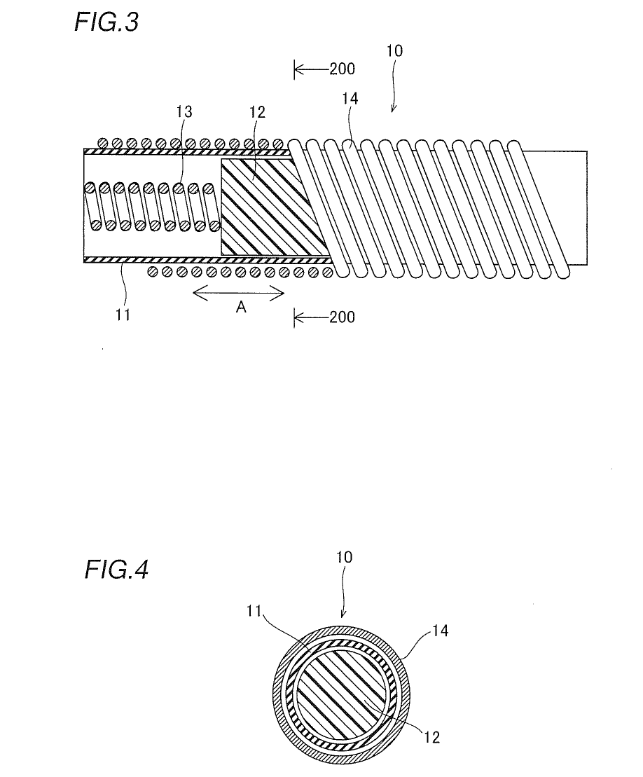

As shown in FIGS. 1 and 2, an electronic apparatus 1 is an electronic apparatus having a vertically long shape such as a portable telephone or a remote control. This electronic apparatus 1 comprises a power generator 2 for supplying electric power to an electronic component (not shown) of the electronic apparatus 1. The power generator 2 includes a movable portion 2a linearly vibrating along arrow A following displacement of the electronic apparatus 1 and a conversion portion (not shown) converting kinetic energy by vibration of the movable portion 2a to electric energy. Specific structures of the movable portion 2a of the power generator 2 and the conversion portion will be described in detail later. The electronic apparatus 1 includes a front surface portion 1a provided with buttons 1e for operation of the electronic apparatus 1 by the user, a display portion 1f (see FIG. 1) and the like and a rear surface portion 1b (see FIG. 2). In the electronic apparatus 1 in the used state, as shown in FIGS. 1 and 2, a portion (support portions 100) below a center 1c of the electronic apparatus 1 (on a near side as viewed from the user's position) is generally supported by a hand of the user. The support portions 100 mean a region 110 (see FIG. 1) of the electronic apparatus 1 positioned below the center 1c (gravity center 1g) of the electronic apparatus 1. The buttons 1e are arranged on the same side as the support portions 100 with respect to the center 1c. The display portion 1f is arranged on a side opposite to the support portions 100 with respect to the center 1c. The electronic apparatus 1 in the used state is generally supported from a side of the rear surface portion 1b of the electronic apparatus 1 by the hand of the user. Nonslip structures 1d are provided on regions including portions (support portions 100) grasped by the hand of the user of a part of the front surface portion 1a and a part of each side surface in the surface of the electronic apparatus 1. Each of the nonslip structures 1d is a structure where a material having a high friction coefficient such as rubber is mounted on the surface or fine roughness is provided on the surface, for example. The button 1e is an example of the “operating portion” in the present invention.

According to the first embodiment, the movable portion 2a of the power generator 2 is arranged at a position separated from the support portions 100. More specifically, the movable portion 2a of the power generator 2 is arranged in the vicinity of an end on a side opposite to the portions (support portions 100) grasped by the hand of the user in a long side direction (along arrow B) of the vertically long electronic apparatus 1 with respect to the center 1c of the electronic apparatus 1. The movable portion 2a is arranged on a side opposite to the buttons 1e and on the same side as the display portion 1f with respect to the center 1c. The electronic apparatus 1 has the gravity center 1g in the vicinity of the center 1c (at the same position as the center 1c in the first embodiment). The movable portion 2a of the power generator 2 is arranged above the gravity center 1g of the electronic apparatus 1. According to the first embodiment, the movable portion 2a is so arranged as to vibrate in a direction (along arrow A) perpendicular to the long side direction (along arrow B) of the electronic apparatus 1.

As shown in FIGS. 3 and 4, a power generator 10 includes a cylindrical housing 11, a permanent magnet 12 stored in the housing 11, a spring 13 for vibrating the permanent magnet 12 along arrow A, a coil 14 wound around housing 11. The permanent magnet 12 is an example of the “movable portion” in the present invention. In the power generator 10, the permanent magnet 12 vibrates in the housing 11, thereby allowing generation of a current in the coil 14 due to electromagnetic induction. In the power generator 10, the permanent magnet 12 vibrates following displacement of the electronic apparatus 1 (see FIG. 1) and hence power is generated following the displacement of the electronic apparatus 1.

According to the first embodiment, as hereinabove described, the movable portion 2a of the power generator 2 is arranged on the side opposite to the portions (support portions 100) generally supported by the hand of the user at the time of use of the electronic apparatus 1 by the user with respect to the center 1c of the electronic apparatus 1, so that the movable portion 2a can be arranged at the position separated from the support portions 100. Thus, acceleration applied to the movable portion 2a can be increased in a case where the electronic apparatus 1 is shaken by the hand of the user to generate power, dissimilarly to a case where the movable portion 2a is arranged at a position close to the support portions 100. Thus, the movable portion 2a can be effectively vibrated and hence reduction in power generation efficiency of the power generator 2 can be suppressed.

According to the first embodiment, as hereinabove described, the electronic apparatus 1 is supported at the support portions 100 in the used state, whereby power can be generated during use of the electronic apparatus 1 by shaking the electronic apparatus 1 employing the support portions 100 as supporting points.

According to the first embodiment, as hereinabove described, the movable portion 2a is arranged above the gravity center of the electronic apparatus 1, so that the movable portion 2a can be arranged at the position separated from the support portions 100 in a case where the user grasps the portion (support portions 100) below the gravity center 1g of the electronic apparatus 1 in his hand. Thus, the movable portion 2a can be effectively vibrated in a case where the electronic apparatus 1 is shaken by the hand of the user to generate power, and hence reduction in power generation efficiency of the power generator 2 can be suppressed.

According to the first embodiment, as hereinabove described, the movable portion 2a is arranged on the side opposite to the buttons 1e for operation of the electronic apparatus 1 by the user with respect to the center 1c of the electronic apparatus 1, so that the buttons 1e are arranged at the position corresponding to the portions (support portions 100) generally supported by the hand of the user, and hence the movable portion 2a can be arranged at the position separated from the support portions 100. Thus, the movable portion 2a can be effectively vibrated in the case where the electronic apparatus 1 is shaken by the hand of the user to generate power, and hence reduction in power generation efficiency of the power generator 2 can be suppressed.

According to the first embodiment, as hereinabove described, the movable portion 2a is arranged on the same side as the display portion 1f with respect to the center 1c of the electronic apparatus 1, so that the display portion 1f is arranged on the side opposite to the portions (support portions 100) generally supported by the hand of the user in the vertically long electronic apparatus, and hence the movable portion 2a can be arranged at the position separated from the support portions 100. Thus, the movable portion 2a can be effectively vibrated in the case where the electronic apparatus 1 is shaken by the hand of the user to generate power and hence reduction in power generation efficiency of the power generator 2 can be suppressed According to the first embodiment, as hereinabove described, the movable portion 2a linearly vibrating is so arranged as to vibrate in the direction (along a short side direction of the electronic apparatus 1 (along arrow A)) perpendicular to the long side direction (along arrow B) of the electronic apparatus 1, whereby the direction in which the movable portion 2a vibrates can follow the direction in which the electronic apparatus 1 is displaced in the case where the electronic apparatus 1 is shaken by the hand of the user. Thus, kinetic energy of the electronic apparatus 1 can be effectively applied to the movable portion 2a and hence power generation efficiency can be improved.

According to the first embodiment, as hereinabove described, the movable portion 2a is arranged in the vicinity of the end on the side opposite to the support portions 100 in the long side direction (along arrow B) of the electronic apparatus 1 with respect to the center 1c of the electronic apparatus 1, so that the movable portion 2a can be arranged at a position farthest from the support portions 100. Thus, the movable portion 2a can be further effectively vibrated in the case where the electronic apparatus 1 is shaken by the hand of the user to generate power and hence reduction in power generation efficiency of the power generator 2 can be suppressed.

According to the first embodiment, as hereinabove described, the support portions 100 are so formed as to be located below the gravity center 1g of the electronic apparatus 1, whereby the movable portion 2a can be located at the position separated from the support portions 100 when the user grasps the support portions 100 of the electronic apparatus 1 in his hand.

According to the first embodiment, as hereinabove described, the nonslip structures 1d are provided on the region including the portions (support portions 100) grasped the hand of the user, whereby slipping of the electronic apparatus 1 from the hand of the user can be easily suppressed.

### Second Embodiment

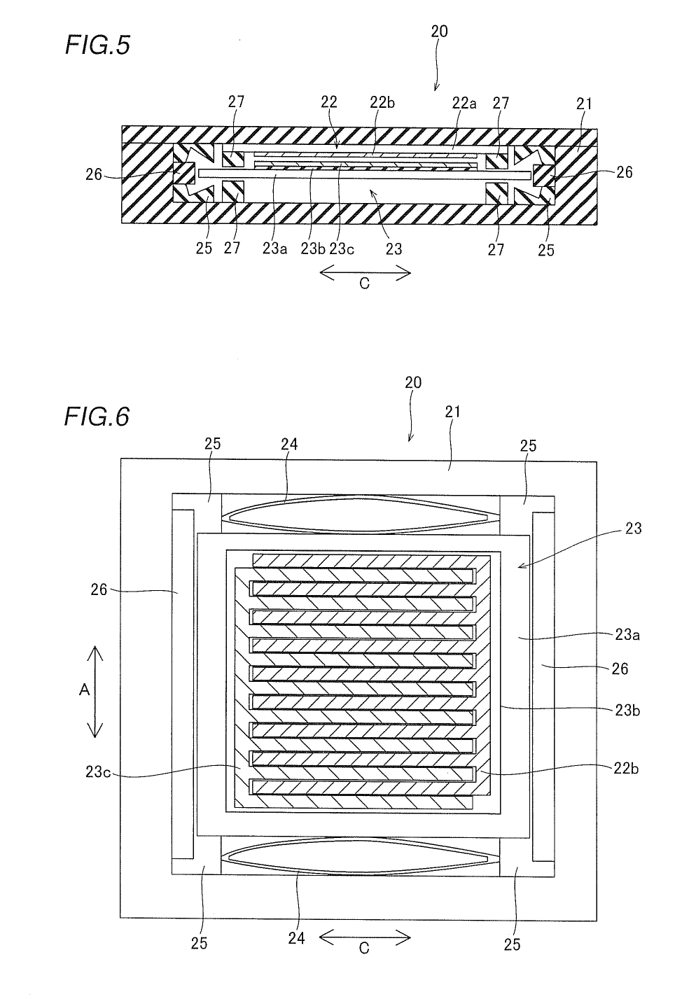

As shown in FIGS. 5 and 6, a power generator 20 comprises a boxlike housing 21, a fixed electrode portion 22 (see FIG. 5) fixed on an inner surface of the housing 21, a movable electrode portion 23 movable linearly, springs 24 (see FIG. 6) for vibrating the movable electrode portion 23 along arrow A, guides 25 and spacers 26 for regulating a lateral position (along arrow C) of the movable electrode portion 23 and spacers 27 (see FIG. 5) for regulating a longitudinal position of the movable electrode portion 23. The movable electrode portion 23 is an example of the “movable portion” in the present invention. The fixed electrode portion 22 includes a substrate 22a and an interdigitally formed collector 22b. The movable electrode portion 23 includes a substrate 23a, an electret film 23b formed on a surface of the substrate 23a, a guard electrode 23c interdigitally formed on a surface of the electret film 23b. In the power generator 20, the movable electrode portion 23 including the electret film 23b vibrates in the housing 21, so that the quantity of charges induced in the collector 22b by electrostatic induction can be changed. Thus, a current can be generated in a circuit (not shown) connected to the guard electrode 23c and the collector 22b. In the power generator 20, the movable electrode portion 23 vibrates following displacement of the electronic apparatus 1 (see FIG. 1), and hence power is generated following the displacement of the electronic apparatus 1.

The effects of the second embodiment are similar to those of the aforementioned first embodiment.

### Third Embodiment

An electronic apparatus 30 according to a third embodiment is provided with structures in which a user easily grasps the electronic apparatus 30, dissimilarly to the electronic apparatus according to the aforementioned first embodiment where the nonslip structures 1d are provided.

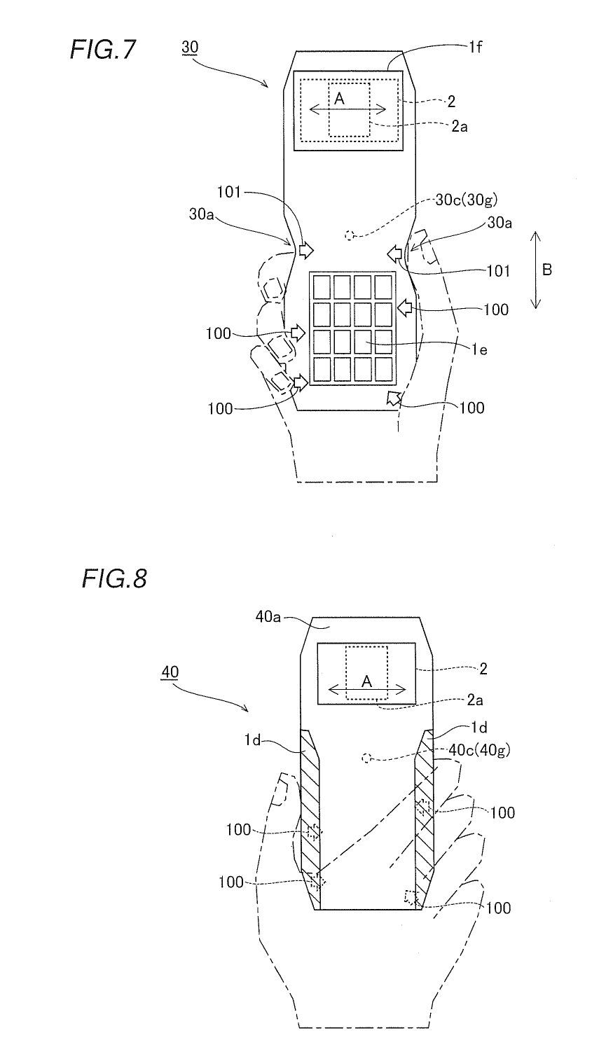

In the electronic apparatus 30 according to the third embodiment, recess portions 30a for placing fingers of the user in grasping by the user are provided below (on a near side as viewed from the user's position) a center 30c of the electronic apparatus 30. In the electronic apparatus 30 in the used state, portions (support portions 101) corresponding to the recess portions 30a are generally supported by a hand of the user, as shown in FIG. 7. A movable portion 2a of a power generator 2 is arranged in the vicinity of an end opposite to the recess portions 30a in a long side direction (along arrow B) of the electronic apparatus 30 with respect to the center 30c (gravity center 30g) of the electronic apparatus 1. The remaining structure of the electronic apparatus 30 according to the third embodiment is similar to that of the electronic apparatus according to the aforementioned first embodiment.

According to the third embodiment, as hereinabove described, the recess portions 30a for placing fingers of the user in grasping by the user are provided below (on the near side as viewed from the user's position) the center 30c of the electronic apparatus 30 and are arranged on the side opposite to the recess portions 30a with respect to the center 30c of the electronic apparatus 30, whereby the recess portions 30a located on the side opposite to the movable portion 2a with respect to the center 30c can be grasped when the user uses the electronic apparatus 30. Therefore, the movable portion 2a can be arranged at a position separated from the support portions 101 grasped by the hand of the user in the used state. Thus, the movable portion 2a can be effectively vibrated in a case where the electronic apparatus 30 is shaken by the hand of the user to generate power, and hence reduction in power generation efficiency of the power generator 2 can be suppressed.

Although the present invention has been described and illustrated in detail, it is clearly understood that the same is by way of illustration and example only and is not to be taken by way of limitation, the spirit and scope of the present invention being limited only by the terms of the appended claims.

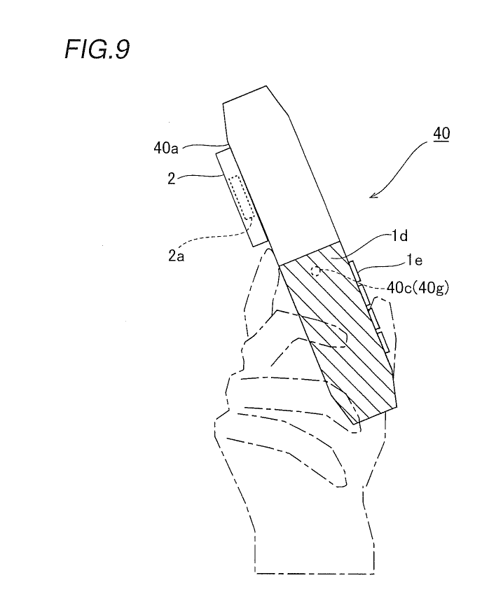

For example, while the power generator 2 is built in the electronic apparatus in the aforementioned first embodiment, the present invention is not restricted to this but a power generator 2 may be mounted on an outer portion of an electronic apparatus 40 as in the electronic apparatus 40 according to a first modification of the first embodiment shown in FIGS. 8 and 9. In this electronic apparatus 40, the power generator 2 is integrally mounted on a rear surface 40a of the electronic apparatus 40. Also in the electronic apparatus 40 according to the first modification, the power generator 2 is so mounted that a movable portion 2a is arranged on a side opposite to support portions 100 with respect to a center 40c (gravity center 40g) of the electronic apparatus 40. In a case where the power generator 2 is mounted outside, the power generator 2 may be detachably attached to the electronic apparatus 40.

While the electromagnetic induction power generator 10 and the electrostatic induction power generator 20 are shown as specific examples of the power generators 2 in the aforementioned first and second embodiments respectively, the present invention is not restricted to this but another power generator such as a capacitance power generator or a piezoelectric power generator may be alternatively employed.

While each of the aforementioned first and second embodiments of the present invention is applied to the electronic apparatus 1 used while being grasped and supported by the hand of the user, such as a portable telephone or a remote control, the present invention is not restricted to this but is also applicable to another electronic apparatus such as a portable music player, a voice recorder and a portable game machine, or another electronic apparatus worn on a body or clothing of the user such as a pedometer or a pager.

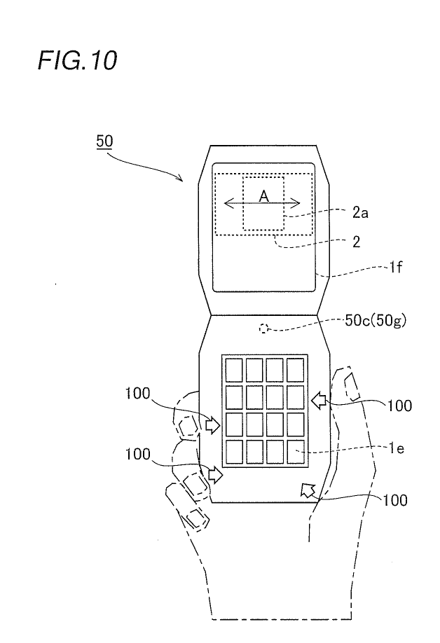

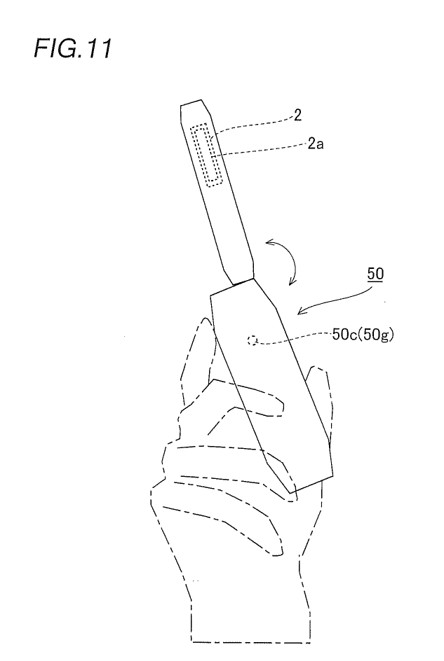

The movable portion 2a is arranged on the side opposite to the support portions 100 grasped by the hand of the user with respect to the center of the electronic apparatus in the aforementioned first embodiment. In a fold-up electronic apparatus, in a case where positions of a gravity center before and after folding are different as in an electronic apparatus 50 according to a second modification of the first embodiment shown in FIGS. 10 and 11, it is only necessary to determine the position of a movable portion 2a of a power generator 2 by a center 50c (gravity center position 50g) in the used state of the electronic apparatus 50, namely a state of before folding the electronic apparatus 50. Similarly, also in a case of a slide electronic apparatus, it is only necessary to determine the position of a movable portion of a power generator by a center position (gravity center position) in a used state.

While the power generator 2 including the movable portion 2a linearly vibrating is employed in each of the aforementioned first to third embodiments, the present invention is not restricted to this but a power generator including a movable portion rotatably moving may alternatively be employed.

While the movable portion 2a is so arranged as to vibrate in the direction perpendicular to the long side direction (along arrow B) of the electronic apparatus 1 in each of the aforementioned first to third embodiments, the present invention is not restricted to this but the direction in which the movable portion 2a vibrates may be not be the direction perpendicular to the long side direction so far as the direction in which the movable portion 2a vibrates is a direction intersecting with the long side direction.

While each of the aforementioned first to third embodiments of the present invention is applied to the electronic apparatus having the vertically long shape, the present invention is not restricted to this but the present invention may be applied to an electronic apparatus having any shape.

What is claimed is:

1. An electronic apparatus comprising:
a power generator including a movable portion displaced by kinetic energy acting on an electronic apparatus body and a conversion portion converting displacement of said movable portion to electric energy, wherein
said movable portion of said power generator is arranged at a position separated from a support portion of said electronic apparatus body.

2. The electronic apparatus according to claim 1, wherein
said support portion is arranged below said movable portion.

3. The electronic apparatus according to claim 2, wherein
said support portion is arranged below a gravity center of said electronic apparatus body.

4. The electronic apparatus according to claim 1, wherein
said electronic apparatus body is so formed as to be supported at said support portion in a used state.

5. The electronic apparatus according to claim 1, wherein
said movable portion is arranged above a gravity center of said electronic apparatus body.

6. The electronic apparatus according to claim 1, further comprising an operating portion for operation of said electronic apparatus body by a user, wherein
said movable portion is arranged on a side opposite to said operating portion with respect to a center of said electronic apparatus body.

7. The electronic apparatus according to claim 6, wherein
said movable portion is so arranged as to overlap with said operating portion in plan view.

8. The electronic apparatus according to claim 1, further comprising a display portion, wherein
said movable portion is arranged on the same side as said display portion with respect to a center of said electronic apparatus body.

9. The electronic apparatus according to claim 1, wherein
said movable portion is so formed as to linearly vibrate, and
said movable portion is so arranged as to vibrate in a direction intersecting with a long side of said electronic apparatus body.

10. The electronic apparatus according to claim 9, wherein
said movable portion is so arranged as to vibrate in a direction substantially perpendicular to said long side of said electronic apparatus body.

11. The electronic apparatus according to claim 1, wherein
said movable portion is so formed as to linearly vibrate, and
said movable portion is so arranged as to vibrate along an extensional direction of a short side of said electronic apparatus body.

12. The electronic apparatus according to claim 1, wherein
said movable portion is arranged in the vicinity of an end on a side opposite to said support portion in a long side direction of said electronic apparatus body with respect to a center of said electronic apparatus body.

13. The electronic apparatus according to claim 1, wherein
said support portion is provided with a nonslip structure.

14. The electronic apparatus according to claim 1, wherein
said power generator is so formed as to convert kinetic energy acting on said electronic apparatus body to electric energy due to electromagnetic induction by vibration of said movable portion.

15. The electronic apparatus according to claim 14, wherein
said movable portion includes a permanent magnet, and
said power generator includes a housing, said permanent magnet stored in said housing and a coil wound around said housing.

16. The electronic apparatus according to claim 1, wherein
said movable portion includes a movable electrode having an electret film, and
said power generator is so formed as to convert kinetic energy acting on said electronic apparatus body to electric energy due to electrostatic induction by vibration of said movable electrode.

17. The electronic apparatus according to claim 1, wherein
said electronic apparatus body is provided with a recess portion for placing a finger of a user in grasping by the user, arranged below said movable portion.

18. The electronic apparatus according to claim 1, wherein
said power generator is so mounted as to be detachably attached to an outer portion of said electronic apparatus body.

19. The electronic apparatus according to claim 1, wherein
said electronic apparatus body is so formed as to be foldable from an open state, and said movable portion is arranged above a gravity center of said electronic apparatus body in the open state.

20. A portable telephone comprising:
a power generator including a movable portion displaced by kinetic energy acting on an electronic apparatus body and a conversion portion converting displacement of said movable portion to electric energy, wherein
said movable portion of said power generator is arranged at a position separated from a support portion of said electronic apparatus body.
